(19) United States
(12) Patent Application Publication
(10) Pub. No.: US 2010/0287505 A1
(43) Pub. Date: Nov. 11, 2010

(54) User Input for Hand-Held Device

(75) Inventor: Rodney Owen Williams, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/435,546

(22) Filed: May 5, 2009

(51) Int. Cl. G06F 3/048

(52) U.S. Cl. 715/823; 715/834

(57) ABSTRACT

A touch interface for a hand held device having a selection tool is described herein. The selection tool allows a large group of selectable items to be displayed in a relatively small space on a touchscreen display, and appears as an element of a graphical user interface on the touchscreen display. The selection tool comprises a plurality of overlapping bands that are disposed at an angle relative to one another and that rotate about a common central area. Each band includes a subset of selectable items in a larger group of selectable items. A user makes a selection selecting a band containing a desired item as a top-most band and selecting the desired item. The selected item may comprise, for example, an icon representing an application, a file or folder, a menu item, or a character from a large character set.

### BACKGROUND

The present invention relates generally to graphical user interfaces and, more particularly, to a graphical user interface for entering characters or other user selections suitable for hand-held devices.

In recent years, touch interfaces have become increasingly popular for use in mobile telephones and other mobile computing devices. A touchscreen is the main component of a touch interface. A graphical user interface is presented to the user on the touch screen. The user interacts with the mobile communication device by touching elements in the graphical user interface presented on the touchscreen. The use of touch interfaces allows manufacturers to eliminate keypads and keyboards normally used for text entry and, thus, provide room on mobile communication devices for larger displays.

When text entry or character entry is required on a device with a touch interface, a graphic keypad or keyboard may be presented to the user on the touchscreen display. The graphical keypad or keyboard typically consumes a significant portion of the display area. One problem is that a large character set can consume a lot of display space. The space requirement can be reduced by reducing the size of the keys; however, if the size of the keypad or keyboard is reduced too much, a stylist may be required for text or character entry, which is generally not desirable to end users. Thus, there remains a need for a method of entering characters from a large character set that requires only a small amount of space while avoiding the need to use a stylist for text or character entry.

Similar problems may also be encountered when the user is required to select an item from a large group of items. For example, a mobile device may have many applications represented as icons on a touch screen display. To run an application, the user must select the corresponding icon from a large group of displayed icons, which may consume a lot of space on the touch screen display. Also, displaying a file system with many files or folders, or displaying a menu system with many submenus and menu items, can take a lot of space on the display. Therefore, there is also a need for a general selection tool to enable a user to select desired items from a large group of items.

### SUMMARY

The present invention relates to a touch interface for a mobile communication device having a selection tool that allows a large group of selectable items to be displayed in a relatively small space on a touchscreen display. The selection tool appears as an element of a graphical user interface on the touchscreen display. The selection tool comprises a plurality of overlapping bands that are disposed at an angle relative to one another and that rotate about a common central area. Each band includes a subset of selectable items in a larger group of selectable items. A user makes a selection selecting a band containing a desired item as a top-most band and selecting the desired item. The selected item may comprise, for example, an icon representing an application, a file or folder, a menu item, or a character from a large character set.

In one exemplary embodiment, the selection tool is designed for entering text or characters from a large character set while using only a small portion of the display area. When a text entry or character entry mode is entered, the graphical user interface displays one or more selection tools which are used as selection tools for character entry. Each selection tool comprises a plurality of overlapping bands that are disposed at an angle relative to one another and that rotate about a common central area. Each band includes a subset of characters from a character set. A user enters text or characters by selecting a band containing a desired character as a top-most band, rotating the band to change the position of the characters on the band, and selecting the desired character. The selection tools enable a large character set to be displayed in a relatively small area of the display so that more area is available for other purposes.

In another exemplary embodiment, the selection tool is designed for selecting an application from a large set of installed applications. When an application selection mode is entered, the graphical user interface displays one or more selection tools. Each selection tool comprises a plurality of overlapping bands that are disposed at an angle relative to one another and that rotate about a common central area. Each band includes icons representing a subset of applications from the set of installed applications. A user selects an application by selecting a band containing an icon representing the desired application and then selecting the icon for the desired application.

### BRIEF DESCRIPTION OF THE DRAWINGS

FIG. 1 illustrates an exemplary hand-held device according to the present invention.

FIG. 2 illustrates the main functional components of the hand-held device.

FIG. 3 illustrates an exemplary selection tool used for character entry.

FIG. 4 illustrates how to switch the active bands on a selection tool for a touch interface.

FIG. 5 illustrates how to bring an active band to the front in a selection tool for a touch interface.

FIG. 6 illustrates how to cycle through multiple selection tools.

FIG. 7 illustrates an exemplary selection tool used for application selection.

FIG. 8 illustrates an exemplary selection tool for selection of a file object in a file system.

FIG. 9 illustrates a selection tool for selection of a menu object in a menu system.

### DETAILED DESCRIPTION

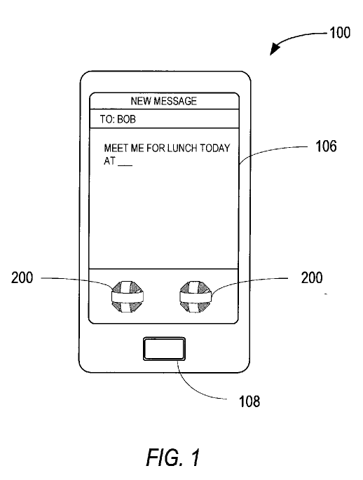

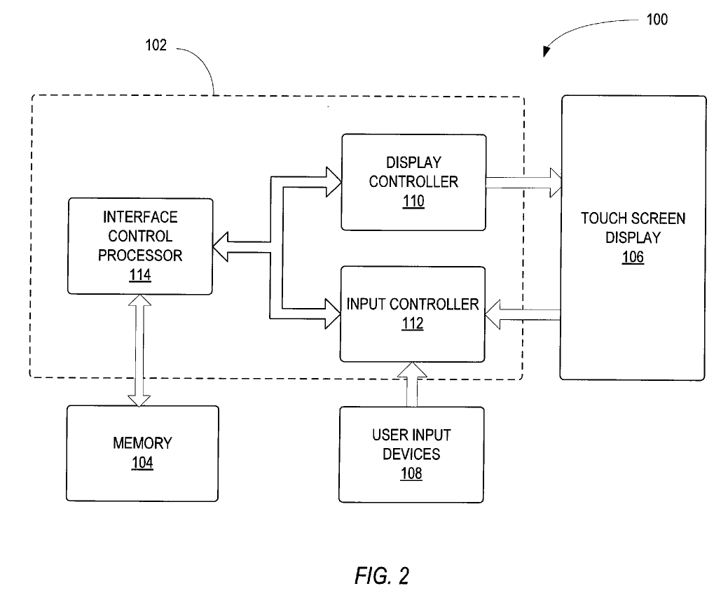

Referring now to the drawings, FIGS. 1 and 2 illustrate an exemplary mobile computing device indicated generally by the numeral 100. The mobile computing device 100 may, for example, comprise a personal digital assistant (PDA), mobile telephone, smart phone, laptop computer, or hand-held computer.

As shown in FIG. 2, mobile computing device 100 typically comprises, in its most basic configuration, a processing circuit 102, memory 104, display 106, and one or more user input devices 108. The processing circuit 102 may comprise one or more microcontrollers, microprocessors, hardware, or a combination thereof. Processing circuit 102 includes a display controller 110 for controlling display 106, an input controller 112 for detecting user input, and an interface control processor 114 programmed and configured to operate as will be hereinafter described. Memory 104 stores computer programs and instructions executed by the processing circuits 102. Memory 104 may comprise volatile memory such as random access memory for temporary storage of data and instructions and non-volatile memory such as read-only memory, FLASH memory, etc., for permanent storage of computer programs and data. The display 106 and user input devices 108 provide a user interface to enable a user to interact with and operate the mobile computing device 100. The processing circuits 102 output information via the display controller 110 to the display 106 for viewing by the user, and receive user input via input controller 112 from the display 106 and user input devices 108. The display 106 may comprise, for example, a touch screen display that also functions as a user input device 108. User input devices 108 may comprise a keypad, buttons, touch pads, joysticks, trackballs, and other common computer input devices.

The mobile computing device 100 may also have additional features not illustrated in FIGS. 1 and 2. For example, mobile computing device 100 may include a communication circuit to enable the mobile computing device 100 to communicate with other devices over communication networks. The communication circuit may provide interfaces for communicating over one or more networks including cellular networks (e.g., WCDMA, LTE, WIMAX), wireless local area networks (e.g., WiFi), and conventional wireline networks. The mobile computing device 100 may also include mass storage devices or other hardware to enable users to store data in a variety of storage media. Mobile computing device 100 may further include magnetic or optical disk drives, or suitable interfaces, e.g., USB, FIREWIRE, etc., for connecting to external storage devices.

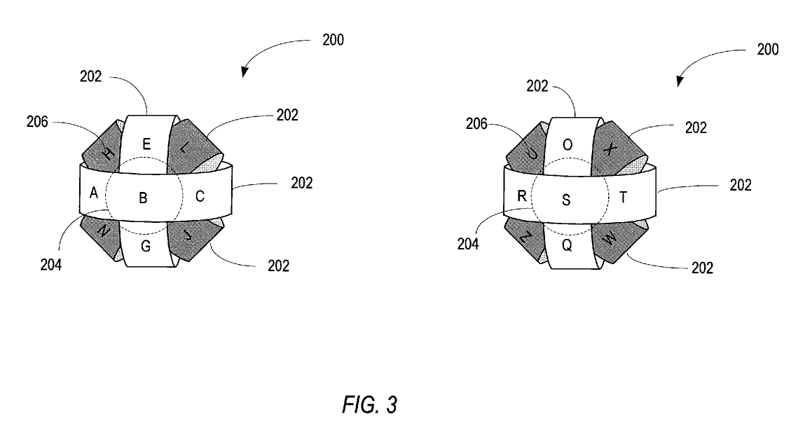

In the exemplary embodiment, the mobile computing device 100 has a large touchscreen display 106 and software that implements a touch interface. The touch interface contains a graphical selection tool 200 that allows a large group of selectable items to be displayed in a relatively small space on the touchscreen display 106. FIG. 3 illustrates one exemplary embodiment of the selection tool 200 designed for entering text or other characters. In a text entry mode, one or more selection tools 200 are displayed on the display 106. As will be described in greater detail below, each selection tool 200 comprises a group of spinning bands 202 that are disposed at an angle with respect to one another and revolve about a common nucleus 204. The nucleus 204 is a central area of the selection tool 200 surrounded by the bands 202. Each band 202 contains a subset of characters 206 from a larger character set. At any given time, one band 202 is displayed in front of or on top of the other bands 202. To enter characters, the user selects one of the bands 202 to bring it to the front, and then selects a character 206 from the front-most band 202.

In the exemplary embodiment, there are four spinning bands 202. One band 202 rotates on a horizontal axis, one band 202 rotates on a vertical axis, and the remaining two bands 202 rotate on tilted axes disposed at a 45 degree angle to the horizontal and vertical axes. In the exemplary embodiment, the bands 202 on the horizontal and vertical axes are considered to be the active bands 202. The bands 202 on the tilted axes are considered to be the inactive bands. The active bands 202 continuously revolve around the nucleus 204. At any given time, one of the active bands 202 is in the forefront. As described in more detail below, the user can select which of the active bands 202 is in front. The user can select characters 206, for example, by tapping the selection tool 200 when a desired character on the front-most band 202 rotates to a predetermined position, e.g., to a front-most position at or near the middle of the visible portion of the selected band 202.

The selection tool 200 is displayed to the user as a graphical object on a touchscreen 106. In the exemplary embodiment, two selection tools 200 are displayed at any given time, although more selection tools may be available and hidden from view or have reduced visibility (e.g., such as being portrayed as a very small selection tool). The user interacts with the selection tool 200 by touch gestures. For example, a touchpad stroke at an angle is interpreted as a band activation input. In response to the band activating input, the processing circuit 102 rotates the selection tool 200 and switches the active set of bands 202. A horizontal stroke moving right to left across the selection tool 200 may be interpreted as a back button keypress. A horizontal stroke moving left to right across a selection tool 200 may be interpreted as a band selection input and brings the horizontal band to the front. If the horizontal band is already on the front, the horizontal stroke may be interpreted as a band rotation input that changes the spin velocity of the band 202. In some embodiments, the bands 202 may be stationary unless rotated by the user. In this case, the band rotation input causes the band 202 to be rotated. A horizontal stroke above or below the selection tool 200 is interpreted as a tool selection input and cycles the selection tools 200 that are visible to the user on the display 106. A vertical stroke in a downward direction may be interpreted as an ENTER or RETURN keypress. A vertical stroke in an upward direction across the selection tool 200 is interpreted as a band selection input and brings the vertical band 202 to the front. If the vertical band is already on the front, the upward vertical stroke may be interpreted as a band rotation input that changes the spin velocity of the vertical band 202. In some embodiments, the bands 202 may be stationary unless rotated by the user. In this case, the band rotation input causes the bands to be rotated. A tap anywhere on the selection tool 200 is interpreted as a character selection input. In response to the character selection input, the processing circuit 102 selects the character at the center position of the front-most band 202 and outputs the selected character.

Table 1 below summarizes an exemplary set of gestures for manipulating the selection tool 200 according to one embodiment of the invention. Those skilled in the art will appreciate that additional gestures may be defined. Further, those skilled in the art will appreciate that both single touch and multi-touch gestures can be used.

TABLE 1
Touch Gestures for Character Entry

| Gesture | Location/Direction | Condition | Action |
|---|---|---|---|
| Horizontal stroke | L-to-R across | Horizontal band top | Change spin |
| | selection tool | | velocity of horizontal |
| | | | band or rotate |
| | | | horizontal band |
| Horizontal stroke | L-to-R across | Horizontal band | Bring horizontal |
| | selection tool | behind vertical band | band to front |
| Horizontal stroke | R-to-L across | n/a | Backspace |
| | selection tool | | |
| Vertical stroke | Upward stroke | Vertical band on top | Change spin |
| | across selection tool | | velocity of vertical |
| | | | band or rotate |
| | | | vertical band |
| Vertical stroke | Upward stroke | Vertical band | Bring vertical band |
| | across selection tool | behind horizontal | to front |
| | | band | |
| Vertical Stroke | Downward stroke | n/a | Enter or return |
| | across selection tool | | |
| Diagonal stroke | Across selection | n/a | Switch active bands |
| | tool | | and rotate selection |
| | | | tool |
| Tap | On selection tool | n/a | Select character at |
| | | | center position on |
| | | | front band |
| Tap and hold | On selection tools | n/a | Select character at |
| | | | center position and |
| | | | repeat until released |
| Horizontal stroke | Above or below | n/a | Change selection |
| | selection tool | | tools |
| Vertical Stroke | To right or left side | n/a | Shift |
| | of selection tool | | |
| Tap and hold | Between selection | n/a | Hide/dismiss |
| | tools | | selection tools |

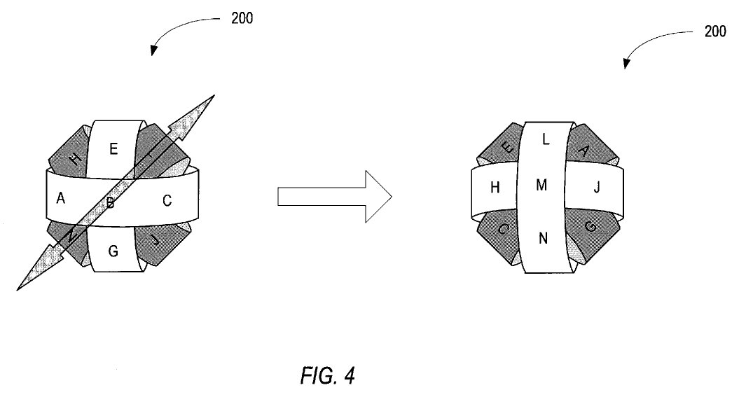

FIG. 4 illustrates how the user switches the set of active bands 202. To switch the active set of bands, the user makes a diagonal stroke with a thumb or finger across the selection tool as shown on the left in FIG. 4. Upon detection of the diagonal stroke, the previously inactive bands 202 are made active and the previously active bands 202 are made inactive. Also, the selection tool 200 displayed on the touchscreen display 106 is rotated so that the new active bands 202 are on the horizontal and vertical axes.

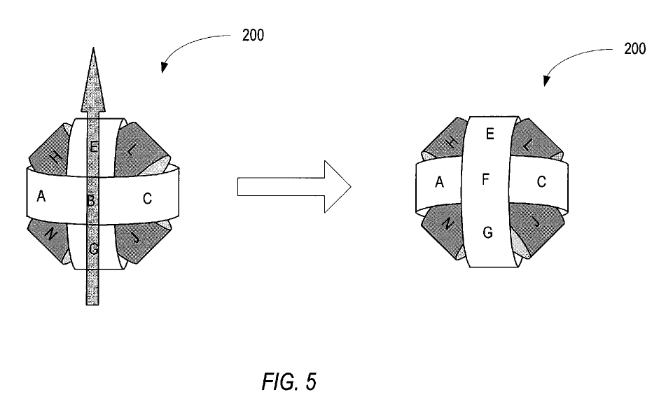

FIG. 5 illustrates how the user brings an active band 202 to the front. On the left side of FIG. 5, a selection tool 200 is shown with the horizontal band 202 in front. To bring the vertical band 202 to the front, the user makes an upward vertical stroke across the selection tool 202. Upon detection of the upward vertical stroke, the vertical band is brought to the front of the selection tool 200. The user may then select a character from the vertical band 202.

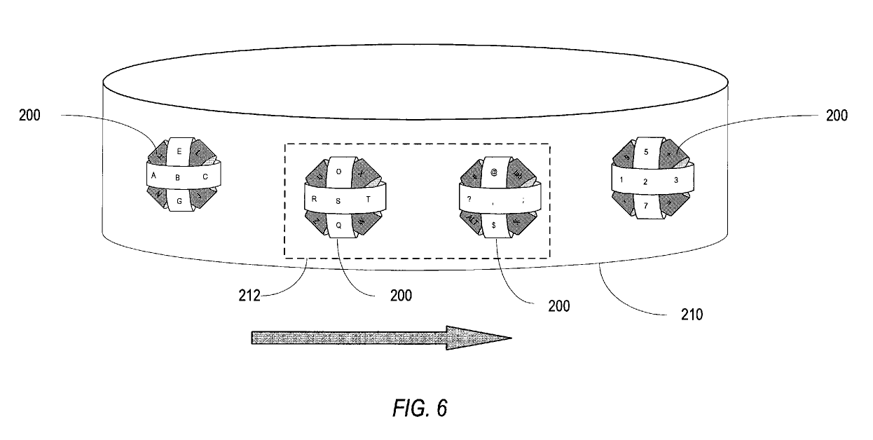

In the exemplary embodiment shown in FIGS. 1-5, two selection tools 200 are displayed to the user at a time on the touchscreen display 106. The user may use two thumbs or fingers to interact with the selection tools 200. Although only two selection tools 200 are displayed at a time, there may be additional selection tools 200 which are hidden from view. The user may cycle through the available selection tools 200 by making a horizontal stroke on the touchscreen 106 above or below the display selection tools 200. Conceptually, the selection tools 200 may be thought of as residing on an invisible band 210 as shown in FIG. 6, where the selection tools 200 in section 212 of the invisible band 210 are shown on display 106. When the user makes a horizontal stroke above or below the selection tools 200 on the display 106, the invisible band 210 rotates to position a new selection tool 200 on a display screen 106.

Table 2 below summarizes one exemplary layout of characters on a plurality of selection tools 200 labeled as groups 1-5. Those skilled in the art will appreciate that other character arrangements are also possible.

TABLE 2
Suggested Character Arrangement for English Keyboard

| Group | Band 1 | Band 2 | Band 3 | Band 4 |
|---|---|---|---|---|
| 1 | a b c d | e f g | h i j k | l m n |
| 2 | o p q | r s t | u v w | x y z |
| 3 | ? ! . , | @ & ; - | # % { } | tab ctl alt |
| 4 | Win FN Sp Sym | ( ) < > | [ ] ~ \ | Fn : “ \| |
| 5 | 1 2 3 4 | 5 6 7 8 | 9 0 . = | / * − + |

Selection toll 200 may also be used as a generic selection tool to enable users to select items from any large group of items. For example, the selection tool 200 may be used to select an application from a list of installed applications, to navigate a file system and select folders or files, or to navigate a menu system and make select menu items.

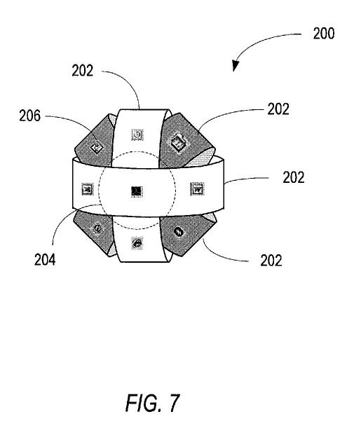

FIG. 7 illustrates an exemplary selection tool 200 that may be used for selecting and launching applications from a list of installed applications. In this embodiment, the spinning bands 202 contain icons that represent different programs installed on the mobile computing device 10. As described above, two bands 202 may be active at any time and one of the active bands 202 may be in front of the other. The techniques described above for activating and selecting bands 202 may be used in this embodiment. A touchpad stroke at an angle rotates the selection tool and switches the active set of bands 202. A horizontal stroke moving right to left across the selection tool 200 is interpreted as a back button keypress. A horizontal stroke moving left to right across a selection tool 200 will bring the horizontal band to the front. If the horizontal band is already on the front, the horizontal stroke gesture can change the spin velocity. A horizontal stroke above or below the selection tool cycles the controls that are visible to the user on the display. A vertical stroke in a downward direction across a selection tool will select, but not run, an application. In this case, a new selection tool 200 with subfolders or files associated with the selected application may be displayed to the user. When a folder is selected, another selection tool 200 may be displayed showing the files and folders in the selected folder.

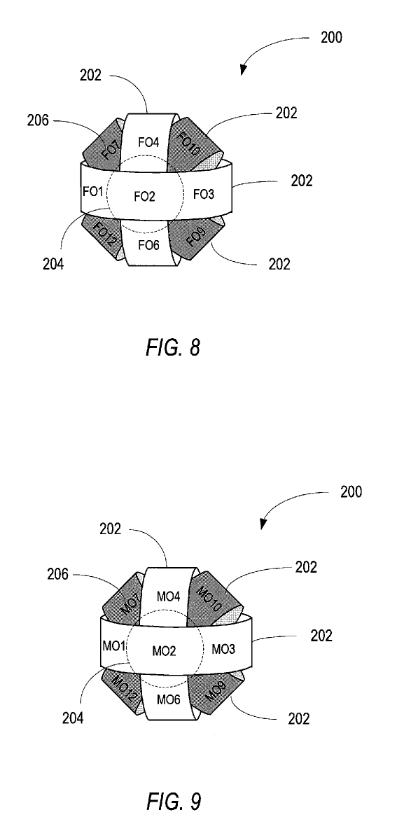

In another exemplary embodiment shown in FIG. 8, selection tool 200 may be used to navigate a file system and select a file system object (FO), such as a file or folder. The selectable items comprise icons representing files or folders in a file system. When an icon is selected, the FO corresponding to the selected icon is selected. If the selected item is a folder, another selection tool 200 may be displayed showing the file system objects in the selected folder. If the selected item is a file, the application corresponding with the selected file may be opened with a corresponding application.

In another exemplary embodiment shown in FIG. 9, selection tool 200 may be used to navigate a menu system and select a menu object (MO). The selectable items comprise menu items associated with specific functions or sub-menus. If the selected menu object is a sub-menu, another selection tool 200 may be displayed containing the menu objects for the selected submenu. If the selected menu object is a menu item associated with a specific function, processing circuit 102 may execute the function.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method implemented by a hand held device of receiving character input from a user, said method comprising:
displaying a selection tool on a display of said hand held device, said selection tool comprising a plurality of overlapping bands that are disposed at an angle relative to one another and that rotate about a common nucleus, each band including a different subset of selectable items from a large group of selectable items;
detecting a band selection input;
selecting one of said bands and displaying the selected band as a front-most band of said selection tool responsive to said band selection input;
detecting an item selection input; and
selecting one of said items on the front-most band responsive to said item selection input.

2. The method of claim 1 further comprising:
detecting a band activation input; and
selecting a subset of said overlapping bands as an active set of bands.

3. The method of claim 2 wherein selecting one of said bands and displaying the selected band as the front-most band of said selection tool responsive to said band selection input comprises selecting one of said bands in said active set to be the front-most band responsive to said band selection input.

4. The method of claim 2 wherein the active set comprises two bands disposed generally perpendicular to one another, the method further comprising rotating said selection tool such that the bands in the active set rotate respectively about horizontal and vertical axes.

5. The method of claim 4 further comprising visually differentiating the active set of bands from an inactive set of bands on the display.

6. The method of claim 1 further comprising:
detecting a tool selection input; and
selecting one or more selection tools and displaying the selected selection tools on said display responsive to said tool selection input.

7. The method of claim 1 further comprising displaying two or more selection tools on said display.

8. The method of claim 1 further comprising:
detecting a band rotation input; and
changing a spin velocity of the front-most band responsive to the band rotation input.

9. The method of claim 1 further comprising:
detecting a band rotation input; and
rotating the front-most band responsive to the band rotation input.

10. The method of claim 1 wherein said selectable items comprise characters, and wherein the selected characters are output responsive to detection of the item selection input.

11. The method of claim 1 wherein said selectable items comprise icons representing installed applications, and wherein an application corresponding with the selected icon is selected responsive to detection of the item selection input.

12. The method of claim 1 wherein said selectable items comprise icons representing files or folders in a file system, and wherein a file system object corresponding with the selected icon is selected responsive to detection of the item selection input.

13. The method of claim 1 wherein said selectable items comprise menu objects in a menu system, and wherein a function associated with the selected menu object is executed responsive to detection of the item selection input.

14. A hand held device comprising:
a display;
a user input; and
an interface control processor operatively connected to said display and said user input for implementing a graphical user interface, said interface control processor configured to:
display a selection tool on a display of said hand held device, said selection tool comprising a plurality of overlapping bands that are disposed at an angle relative to one another and that rotate about a common center, each band including a different subset of selectable items from a large group of selectable items;
detect a band selection input;
select one of said bands and displaying the selected band as a front-most band of said selection tool responsive to said band selection input;
detect an item selection input; and
select one of said items on the front-most band responsive to said item selection input.

15. The hand held device of claim 14 wherein said interface control processor is further configured to:
detect a band activation input; and
select a subset of said overlapping bands as an active set of bands.

16. The hand held device of claim 15 wherein said interface control processor is configured to select one of said bands in said active set to be the front-most band responsive to said band selection input.

17. The hand held device of claim 15 wherein said active set comprises two bands disposed generally perpendicular to one another, and wherein said interface control processor is further configured to rotate said selection tool such that the bands in said active set rotate respectively about horizontal and vertical axes

18. The hand held device of claim 17 wherein said interface control processor is further configured to visually differentiate the active set of bands from an inactive set of bands on the display.

19. The hand held device of claim 14 wherein said interface control processor is further configured to:
detect a tool selection input; and
select one or more selection tools and display the selected selection tools on said display responsive to said tool selection input.

20. The hand held device of claim 14 wherein said interface control processor is further configured to displaying two or more selection tools on said display.

21. The hand held device of claim 14 wherein said interface control processor is further configured to:
detect a band rotation input; and
change a spin velocity of the front-most band responsive to the band rotation input.

22. The hand held device of claim 14 wherein said interface control processor is further configured to:
detect a band rotation input; and
rotate the front-most band responsive to the band rotation input.

23. The hand held device of claim 14 wherein said selectable items comprise characters, and wherein the selected characters are output by said interface control processor responsive to detection of the item selection input.

24. The hand held device of claim 14 wherein said selectable items comprise icons representing installed applications, and wherein an application corresponding with the selected icon is selected by said interface control processor responsive to detection of the item selection input.

25. The hand held device of claim 14 wherein said selectable items comprise icons representing files or folders in a file system, and wherein a file object corresponding with the selected icon is selected by said interface control processor responsive to detection of the item selection input.

26. The hand held device of claim 14 wherein said selectable items comprise menu objects in a menu system, and wherein a function associated with the selected menu object is executed by said interface control processor responsive to detection of the item selection input.
